(19) United States
(12) Patent Application Publication
(10) Pub. No.: US 2011/0072341 A1
(43) Pub. Date: Mar. 24, 2011

(54) DOCUMENT IMAGE GENERATION SERVER, DOCUMENT IMAGE GENERATION PROGRAM, AND DOCUMENT BROWSING SYSTEM

(75) Inventor: Akira HINO, Tokyo (JP)

(73) Assignee: FUJIFILM Corporation, Tokyo (JP)

(21) Appl. No.: 12/956,670

(22) Filed: Nov. 30, 2010

(30) Foreign Application Priority Data
Jan. 12, 2009 (JP) 2009-273439

(51) Int. Cl. G06F 17/00

(52) U.S. Cl. 715/255

(57) ABSTRACT

In response to a browsing request of a document file from a cellular phone, a document image generation server loads the document file into a RAM. A font size detection section detects font sizes contained in the document file. A document division section divides the document file into predetermined units having approximately the same two dimensional size. A resolution determination section determines a resolution of each document image to be generated from the document file on a unit-by-unit basis in accordance with the smallest font size contained in the unit. A conversion section converts the document file into the document images on a unit-by-unit basis so that each document image has the determined resolution.

### BACKGROUND OF THE INVENTION

1. Field of the Invention

The present invention relates to a document image generation server and program for generating a document image to be browsed on a terminal, and a document browsing system that allows a browse of the document image.

2. Description Related to the Prior Art

Transmission of a document file including, for example, Microsoft Word, Excel, and Power Point files by e-mail and a browse of the document file are carried out everyday in an office. On the other hand, sending an internal document file by the e-mail to the outside or a browse of the internal document file in the outside is concerned in view of information leak.

However, easy access to the internal document file from the outside significantly contributes to improvement in work efficiency. Especially, it is very convenient for a company staff to get access to the internal document file with use of a cellular phone that the staff carries along.

Thus, a technique of a network system in which the cellular phone is used as a thin client is widely developed in recent years. For example, “Virtual PC Center” (made by NEC Corporation) is proposed as a virtual PC type of thin client system. In this “Virtual PC Center”, in response to a document file browsing request from the cellular phone, a server successively converts the requested document file into some images (document images). Then, the server sends the document images to the cellular phone for a browse. According to the thin client system, since the server intensively carries out almost all types of processing and leaves no data to the cellular phone, the information leak is prevented.

By the way, the document file is created in the office in expectation of being printed out on a letter size sheet of paper. In the case of browsing such a document file on a small screen of the cellular phone, the converted document image is partly displayed while zooming in. The displayed document image generally has high resolution, because the document image of low resolution cannot be sharply displayed while zooming in.

However, dealing with the high-resolution document image needs the expensive server and long processing time by the server for displaying the document image on the screen of the cellular phone.

### SUMMARY OF THE INVENTION

An object of the present invention is to shorten processing time required by a thin client system for displaying a document image without using an expensive server.

To achieve the above and other objects of the present invention, a document image generation server according to the present invention includes a document file loading section, a font size detection section, a document file division section, and a conversion section. The document file loading section loads a document file containing information about one or more letters and a font size of each of the letters. The font size detection section detects the font size contained in the document file. The document file division section divides the document file into predetermined units having substantially a same two dimensional size or into blocks each of which has a string of the letters of substantially the same font size. The conversion section converts the document file on a unit-by-unit or block-by-block basis into document images to be browsed on a terminal. A resolution of each of the document images depends on the font size contained in the unit or the block.

Otherwise, a document image generation server according to the present invention includes a document file loading section, a font size detection section, a document file division section, a conversion section, a compression ratio determination section, and a document image compression section. The document file loading section loads a document file containing information about one or more letters and a font size of each of the letters. The font size detection section detects the font size contained in the document file. The document file division section divides the document file into predetermined units having substantially a same two dimensional size or into blocks each of which has a string of the letters of substantially the same font size. The conversion section converts the document file on a unit-by-unit or block-by-block basis into document images to be browsed on a terminal. The compression ratio determination section determines a compression ratio of each of the document images based on the font size contained in the unit or the block. The document image compression section compresses each of the document images at the determined compression ratio on a unit-by-unit or block-by-block basis.

It is preferable that the document image generation server further include an image output section for outputting the document images in response to a request from the terminal.

A document image generation program according to the present invention makes a server execute the steps of loading a document file containing information about one or more letters and a font size of each of the letters; detecting the font size contained in the document file; dividing the document file into predetermined units having substantially a same two dimensional size or into blocks each of which has a string of the letters of substantially the same font size; and converting the document file on a unit-by-unit or block-by-block basis into document images to be browsed on a terminal. A resolution of each of the document images depends on the font size contained in the unit or the block.

Otherwise, a document image generation program according to the present invention makes a server execute the steps of loading a document file containing information about one or more letters and a font size of each of the letters; detecting the font size contained in the document file; dividing the document file into predetermined units having substantially a same two dimensional size or into blocks each of which has a string of the letters of substantially the same font size; converting the document file on a unit-by-unit or block-by-block basis into document images to be browsed on a terminal; determining a compression ratio of each of the document images based on the font size contained in the unit or the block; and compressing each the document images at the determined compression ratio on a unit-by-unit or block-by-block basis.

A document browsing system according to the present invention includes the above document browsing system and terminal.

In the document browsing system, the terminal is preferably a cellular phone.

According to the present invention, it is possible to shorten the processing time required for displaying the document image without using an expensive server.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 a schematic view of a document browsing system;

FIG. 2 is a block diagram of a document image generation server;

FIG. 3 is a block diagram that explains the functions of a CPU according to first and second embodiments;

FIG. 4 is a block diagram of the document image generation server that explains document image generation processing according to the first and second embodiments;

FIG. 5 is a flowchart of the document image generation processing according to the first embodiment;

FIG. 6 is a block diagram that explains the functions of the CPU according to third and fourth embodiments;

FIG. 7 is a block diagram of the document image generation server that explains the document image generation processing according to third and fourth embodiments;

FIG. 8 is a flowchart of the document image generation processing according to the third embodiment;

FIG. 9 is a block diagram that explains the functions of the CPU according to a fifth embodiment;

FIG. 10 is a flowchart of the document image generation processing according to the fifth embodiment;

FIG. 11 is a block diagram that explains the functions of the CPU according to a sixth embodiment;

FIG. 12 is a flowchart of the document image generation processing according to the sixth embodiment;

FIG. 13 is a block diagram that explains the functions of the CPU according to a seventh embodiment;

FIG. 14 is a block diagram of the document image generation server that explains the document image generation processing according to the seventh embodiment; and

FIG. 15 is a flowchart of the document image generation processing according to the seventh embodiment.

### DESCRIPTION OF THE PREFERRED EMBODIMENTS

### First Embodiment

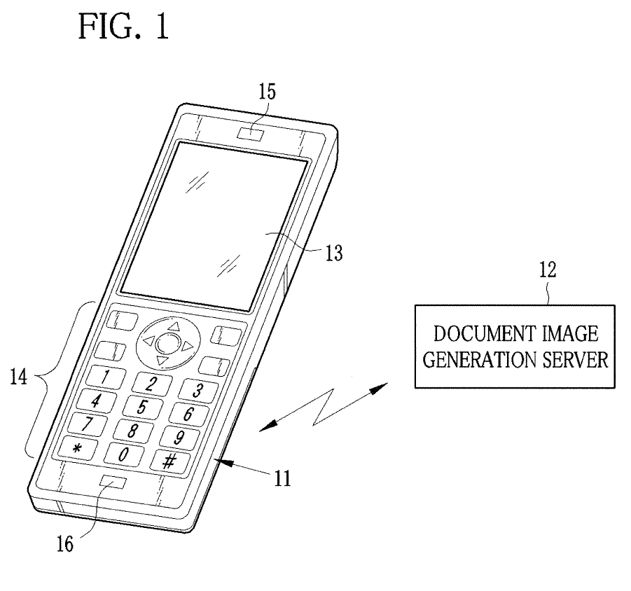

A cellular phone 11 as shown in FIG. 1 has a communication function such as telephone, the Internet, and the like. The cellular phone 11 is connected to a document image generation server 12 or document processing apparatus on the Internet. As the document image generation server 12, a personal computer or the like set up in an office is available.

The document image generation server 12 converts a document file into a plurality of images (document images) on a predetermined unit (for example, a page-by-page) basis, and sends the document images to the cellular phone 11. On the cellular phone 11, the image file can be browsed in an image format. The cellular phone 11 and the document image generation server 12 constitute a document browsing system or document retrieval system for browsing the document file, as described above.

On a front surface of the cellular phone 11, there are provided a liquid crystal display (LCD) 13 and an operation panel 14 including telephone dial buttons and various setup buttons. A speaker 15 is provided above the LCD 13, and a microphone 16 is provided below the operation panel 14. To the speaker 15 and the microphone 16, a telephone unit (not illustrated) containing a communication circuit, a voice processing circuit, and the like is connected.

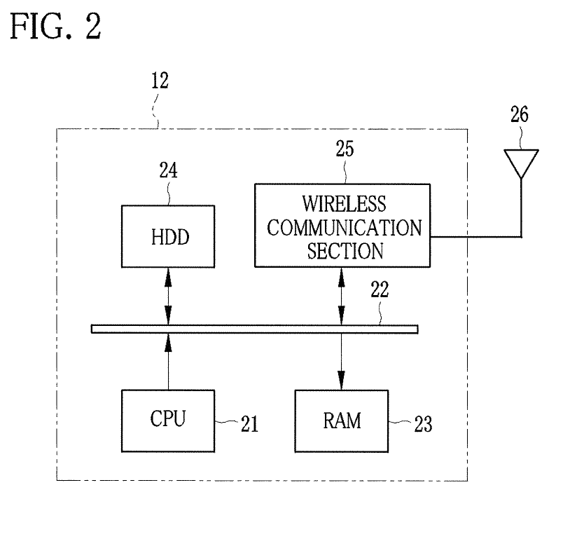

As shown in FIG. 2, the document image generation server 12 is provided with a CPU 21. The CPU 21 controls the whole of the document image generation server 12 in accordance with an operation signal inputted from the operation panel 14 of the cellular phone 11. A RAM 23, a hard disk drive (HDD) 24, and a wireless communication section 25 are connected to the CPU 21 via a data bus 22. To the wireless communication section 25, an antenna 26 is connected.

The RAM 23 is a working memory used when the CPU 21 carries out various types of processing. The HDD 24 stores various programs, including a document image generation program, to be executed by the document image generation server 12, the document files (for example, Microsoft Word, Excel, and Power Point files) to be browsed on the cellular phone 11, and other data. The document file contains information about text data (with alphanumeric data) and a font size by which the text data is displayed.

The CPU 21 loads the programs and data from the HDD 24 into the RAM 23. In other words, the CPU 21 functions as a document file loading section to load the document file. Then, the CPU 21 successively executes the programs and processes the data. The wireless communication section 25 communicates with the cellular phone 11 via the antenna 26.

By the way, the commonly usable document files are of various formats such as the Microsoft Word, Excel, and Power Point. Also, each document file contains various components having different characteristics, such as embedded image data and the text data including a title, a main body of the document, a note, and the like. In most document files, it is generally conceivable that a spatial frequency of the text data is higher than that of diagram data, and a spatial frequency of a small font is higher than that of a large font. Thus, it is rational to estimate an appropriate resolution of the document image to be generated by the document image generation server 12 based on the smallest font size (highest spatial frequency component). Thus, the document image generation server 12 according to a first embodiment determines the resolution of the document image based on the smallest font size contained in the document file.

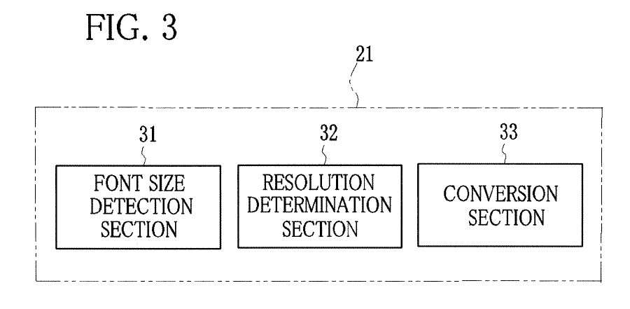

As shown in FIG. 3, a font size detection section 31, a resolution determination section 32, and a conversion section 33 are established in the CPU 21 by execution of the program. The font size detection section 31 scans the document file with use of an API (Application Program Interface) corresponding to the document file to detect the smallest font size contained in the document file. The scan is carried out on a predetermine unit (for example, a page-by-page) basis. The font size detection section 31 also detects the total number of letters contained in a scanned area.

The resolution determination section 32 calculates the resolution of each page of the document image to be generated, based on the smallest font size detected by the font size detection section 31. The resolution D (dpi (dot per inch)) is expressed as follows:

D=72×K/p (1)

Wherein, K (dot) represents the number of dots per letter, p (pt) represents the font size, and 1 (inch) corresponds to 72 (pt). The resolution D increases with reduction in the font size p.

However, if the total number of the letters (alphanumeric characters) contained in the area scanned by the font size detection section 31 is less than a predetermined letter number threshold value Th, the resolution determination section 32 sets the resolution at a predetermined standard value D0, instead of using the above expression (1). The standard value D0 is set lower than the resolution calculated by the above expression (1). This is because in a case where the component other than the text data e.g. the embedded image data occupies a lot of part of the document file, the document image is prevented from having the high resolution more than necessary. The number K of dots per letter, the letter number threshold value Th, and the standard value D0 are fixed parameters, and determined by experiments (trial image generation and visual image check) conducted beforehand.

The conversion section 33 converts the document file on a predetermined unit e.g. a page-by-page basis into a page number of document images so that the each document image has the resolution calculated by the resolution determination section 32. The converted document images are written to the RAM 23, and are successively sent to the cellular phone 11 in response to a browsing request, by the wireless communication section 25 functioning as an image output section. The document images are displayed on the LCD 13 of the cellular phone 11 for a browse.

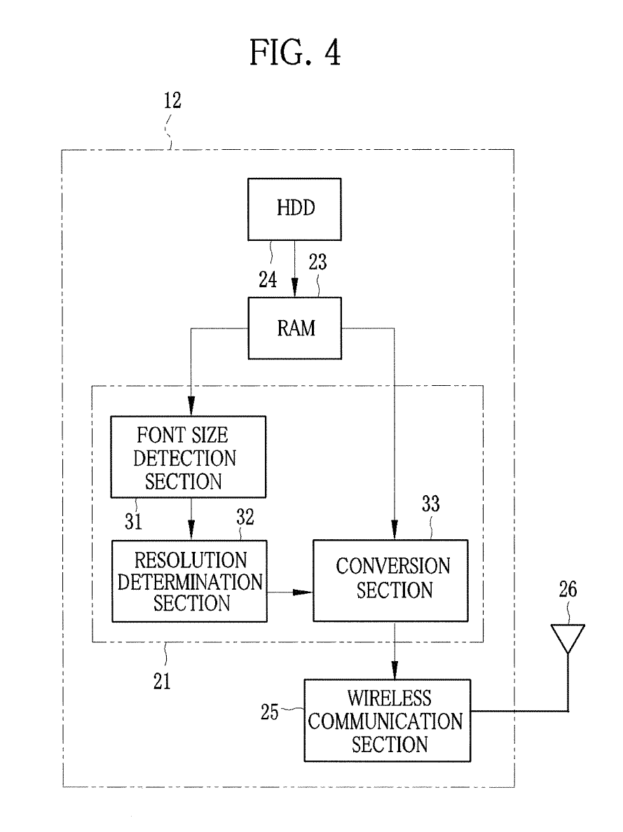

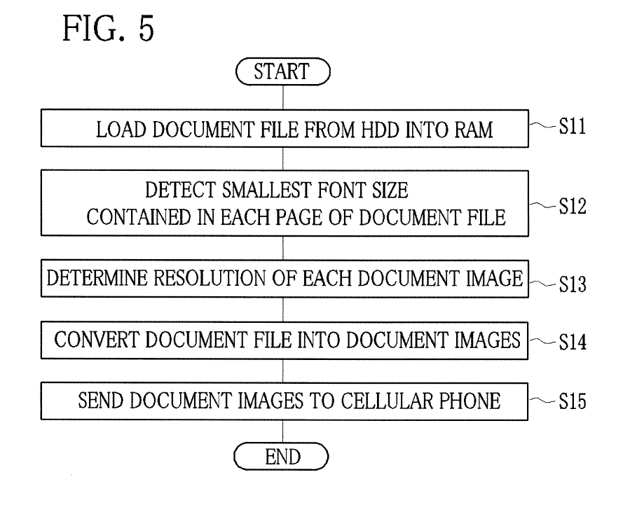

Next, a document image generation process by the document image generation server 12 will be described with referring to FIGS. 4 and 5. When the document file to be browsed is designated with operation of the operation panel 14 of the cellular phone 11, the browsing request of the document file is sent from the cellular phone 11. Upon reception of the browsing request, the document image generation server 12 loads the designated document file from HDD 24 into the RAM 23 (S11).

After the load of the document file into the RAM 23, the font size detection section 31 scans the document file, and detects the smallest font size used in each page of the document file (S12). Then, the resolution determination section 32 determines based on the detected smallest font size the resolution of each document image into which the document file is to be converted (S13).

After the determination of the resolution, the conversion section 33 converts the document file into the document images of the determined resolutions (S14). The document images are successively sent to the cellular phone 11 via the wireless communication section 25 and the antenna 26 (S15), and browsed on the cellular phone 11.

The document browsing system having the above structure can be constructed with the inexpensive server. Also, the document images of the sufficient resolutions can be displayed on the cellular phone in a short processing time.

In this embodiment, the conversion section 33 converts the document file into the document images having the resolutions determined by the resolution determination section 32. However, the conversion section 33 may be supplied with vertical and horizontal dot numbers, and convert the document file into the document images having those dot numbers. The horizontal dot number X is expressed by X=D×W . . . (2), wherein W (inch) represents the width of the document image. The vertical dot number Y is expressed by Y=D×H . . . (3), wherein H (inch) represents the height of the document image.

### Second Embodiment

The resolution of each document image is determined based on the smallest font size contained in each predetermined unit in the first embodiment, but is determined based on a distribution (histogram) of the font sizes in a second embodiment.

The first embodiment notes the smallest font size, but contents written in small letters are sometimes unnecessary for a browser, like a trademark. Also, almost all text data sometimes has the same font size. Thus, it is more rational to estimate the appropriate resolution based on the distribution of the font sizes. Accordingly, the document image generation server 12 according to the second embodiment determines the resolution of the document image on a predetermined unit basis in accordance with the distribution of the font sizes used in the document file.

The font size detection section 31 detects the distribution of the font sizes used in the document file. The resolution determination section 32 determines the resolution of the document image to be generated based on a mode value of the font size. The resolution D is expressed by the above expression (1). However, if the ratio of the number of letters having the font sizes of the mode value or less to the number of all letters contained in the document file is less than a predetermined ratio threshold value Thr, the resolution determination section 32 sets the resolution at the standard value D0, instead of using the above expression (1). The ratio threshold value Thr is a fixed parameter, and is determined by experiments (trial image generation and visual image check) conducted beforehand. Description of the same structure, operation, and effect as those of the first embodiment will be omitted. In the following embodiments, only difference from the other embodiments will be described.

In the second embodiment, the resolution of each document image is determined based on the mode value of the font size, but may be determined based on any value such as an average value or a median value of the font size, as long as it is based on the distribution of the font sizes. In any case, the same effect as that of using the mode value is obtained. In the case of using the mode value, the average value, or the median value, a modification of, for example, assigning an appropriate weight to each font size may be made to the embodiment.

In the second embodiment, the ratio of the number of letters having the font size of the mode value or less is compared to the predetermined ratio threshold value Thr, but a value of multiplying the number of letters by a square of the font size ((number of letters)×(font size)×(font size)) may be evaluated instead. This value is a proxy variable of an area that the text data of each font size occupies.

### Third Embodiment

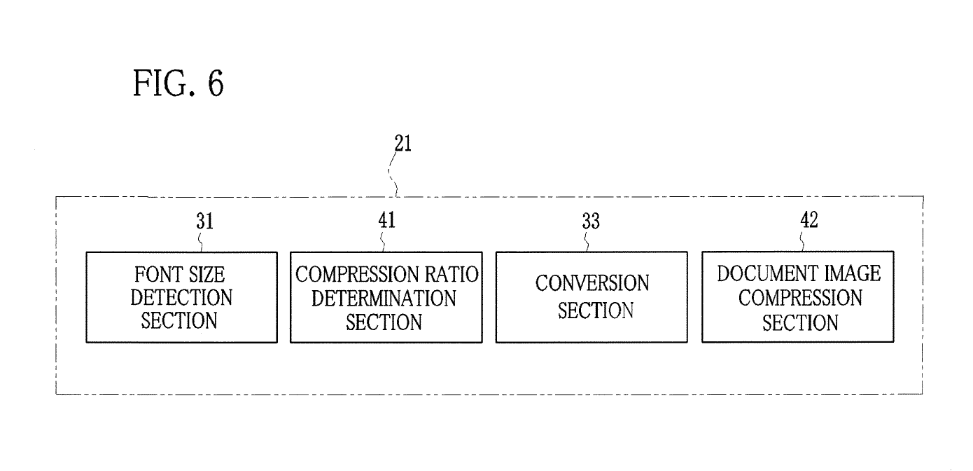

In a third embodiment, a compression ratio of the document image is determined based on the smallest font size used in the document file. As shown in FIG. 6, the font size detection section 31, the conversion section 33, a compression ratio determination section 41, and a document image compression section 42 are established in the CPU 21 by execution of the program. The conversion section 33 converts the document file into the page number of document images.

The compression ratio determination section 41 determines the compression ratio (Q value) of each page of the document image based on the smallest font size detected by the font size detection section 31. A calculation expression of the Q value is not linear due to characteristics of an encoder (document image compression section 42), and is expressed as a nonlinear function. The document image compression section 42 compresses each document image with the Q value determined by the compression ratio determination section 41.

The compressed document images are written to the RAM 23, and are successively sent to the cellular phone 11 in response to the browsing request. The cellular phone 11 decompresses the document images, and displays the document images on the LCD 13 for a browse.

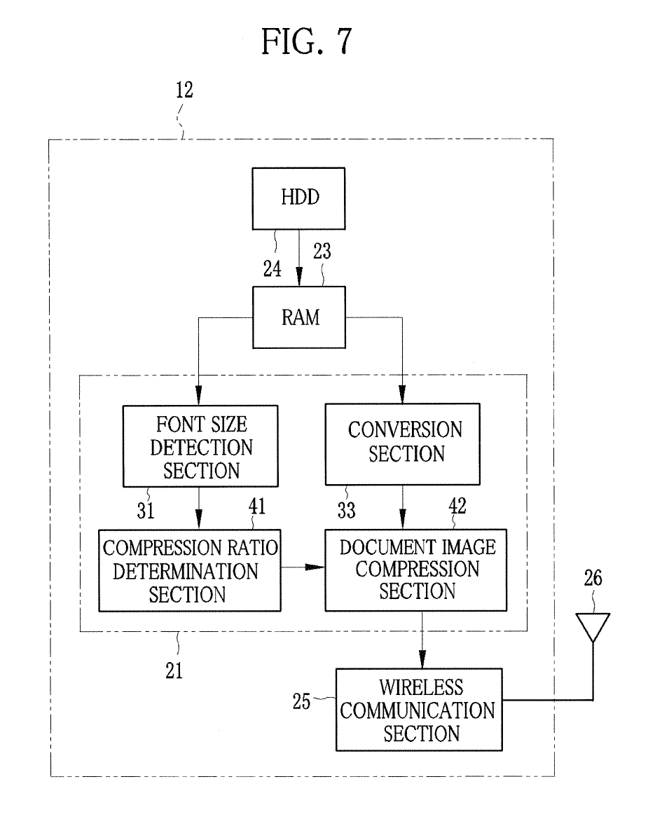

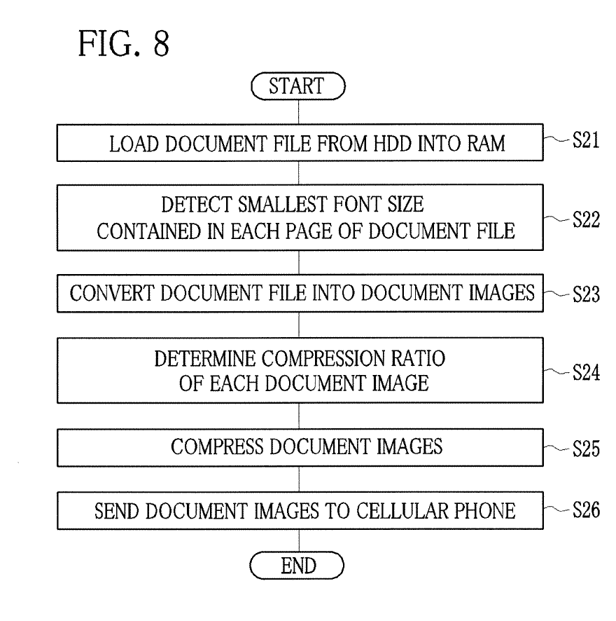

Next, a document image generation process carried out by the document image generation server 12 according to the third embodiment will be described with referring to FIGS. 7 and 8. S21 and S22 are the same as S11 and S12. Then, the conversion section 33 converts the document file into the document images (S23). The compression ratio determination section 41 determines the compression ratio (Q value) of each document image based on the detected smallest font size (S24).

After the determination of the Q value, the document image compression section 42 compresses the document images with the determined Q values (S25). The compressed document images are successively sent to the cellular phone 11 via the wireless communication section 25 and the antenna 26 (S26). Then, the compressed document images are decompressed by the cellular phone 11, and become browsable.

### Fourth Embodiment

In a fourth embodiment, the compression ratio of each document image is determined based on the distribution (histogram) of the font sizes contained in each predetermined unit.

The font size detection section 31 detects the distribution of the font sizes contained in each predetermined unit of the document file. The compression ratio determination section 41 determines the compression ratio (Q value) of each document image based on the mode value of the font size.

As in the case of the second embodiment, the compression ratio of each document image may be determined based on the average value or the median value, instead of the mode value of the font size. In any case of using the mode value, the average value, and the median value, a modification of, for example, assigning an appropriate weight to each font size may be made to this embodiment.

### Fifth Embodiment

In a fifth embodiment, the low-resolution document image is first generated, and then the high-resolution document image is generated as necessary. When the document file has many pages, a large number of the document images are converted from the single document file. Conversion processing requires long time, but all browsers do not browse every page. Also, in the single page, there is a case where browsing only a part of the page is enough and the details of the page, which are to be browsed while zooming in, are unnecessary. Thus, the document image (representative image) of each page is first generated at low resolution to grasp a general view of the page. Then, if a zoom-in request is received, the document image of the requested page or the document images of every page is/are newly generated at high resolution. This allows comprehensive reduction in a data processing amount and a response time to the cellular phone 11.

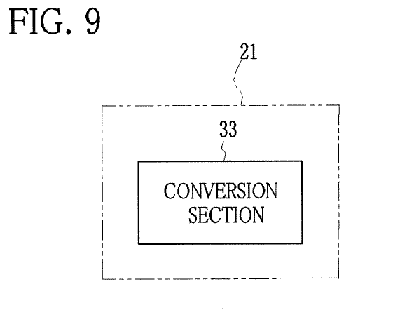

As shown in FIG. 9, the conversion section 33 is established in the CPU 21 by execution of the program. The conversion section 33 converts the document file loaded into the RAM 23 into the low-resolution document images on a page-by-page basis.

If the zoom-in request of the low-resolution document image that is being browsed on the cellular phone 11 is received, the conversion section 33 converts the corresponding page of the document file into the high-resolution document image. However, if the high-resolution document image has already been generated, the conversion is not carried out.

The converted high-resolution document image is written to the RAM 23, and is sent to the cellular phone 11. The high-resolution document image is displayed on the LCD 13 of the cellular phone 11 while zooming in for a browse.

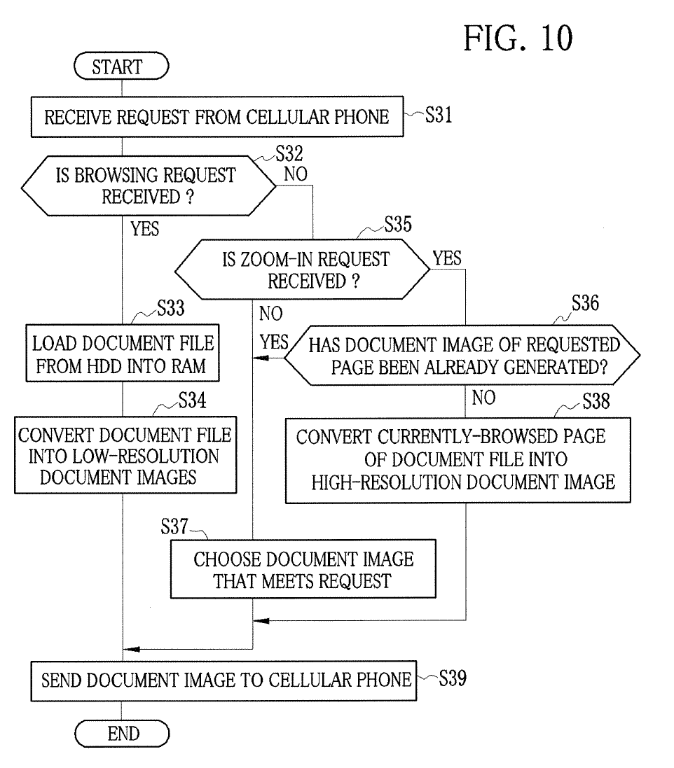

Next, the document image generation process by the document image generation server 12 according to the fifth embodiment will be described with referring to FIG. 10. By operation of the operation panel 14 of the cellular phone 11, the browsing request is sent from the cellular phone 11. The document image generation server 12 receives the request from the cellular phone 11 (S31) . If the document image generation server 12 receives the request to start a browse of the document file (YES in S32) , the requested document file is loaded from the HDD 24 into the RAM 23 (S33). Then, the conversion section 33 converts the document file into the document images of the low resolution (S34).

If while the low-resolution document image is browsed (NO in S32) , the zoom-in request is received (YES in S35) , the document image generation server 12 checks whether or not the high-resolution document image of the requested page has already been generated. If YES in S36, the high-resolution document image of the requested page is chosen (S37). If NO in S36, the conversion section 33 converts the currently-browsed page of the document file into the high-resolution document image (S38).

If while the low-resolution document image is browsed (NO in S32), a request (for example, a zoom-out request or a page turning request) other than the zoom-in request (NO in S35), the document image (low-resolution document image) of the requested page is chosen (S37).

The low-resolution document images generated in S34, the document image chosen in S37, or the high-resolution document image generated in S38 are successively sent to the cellular phone 11 via the wireless communication section 25 and the antenna 26 (S39), and browsed on the cellular phone 11. The document images generated in S34 and S38 are written to the RAM 23, while being sent to the cellular phone 11.

The resolution of the low-resolution document image may depend on the distribution of the font sizes contained in the document file, as in the case of the second embodiment. In this case, the resolution determination section 32 is established in the CPU 21.

The resolution of the high-resolution document image may depend on the smallest font size contained in the corresponding predetermined unit, as in the case of the first embodiment. In this case, the resolution determination section 32 is established in the CPU 21.

In the fifth embodiment, as for the single page, the single low-resolution document image and the single high-resolution document image are generated. However, a plurality of high-resolution document images having stepwise resolutions may be generated in response to magnifications of the zoom-in requests.

### Sixth Embodiment

In a sixth embodiment, the document file is divided into blocks in accordance with the font sizes, and the resolutions of the document image differ from block to block. The text data of the document file generally contains some components such as the title, the main body, and the note. In many cases, the text data has the font sizes different from component to component. The disposition of the text data is localized (the text data of the same font size is disposed together), and the letters of the same or similar font size string in general. The similar font size refers to the font sizes within a predetermined range. For example, a font size of 8 pt is similar to a font size 7 pt or 9 pt. According to these general characteristics, the document image generation server 12 according to the sixth embodiment divides the text data into blocks each of which has a string of the letters of the same or similar font size, and generates the document image of each block at the resolution appropriate to the font size contained in the block.

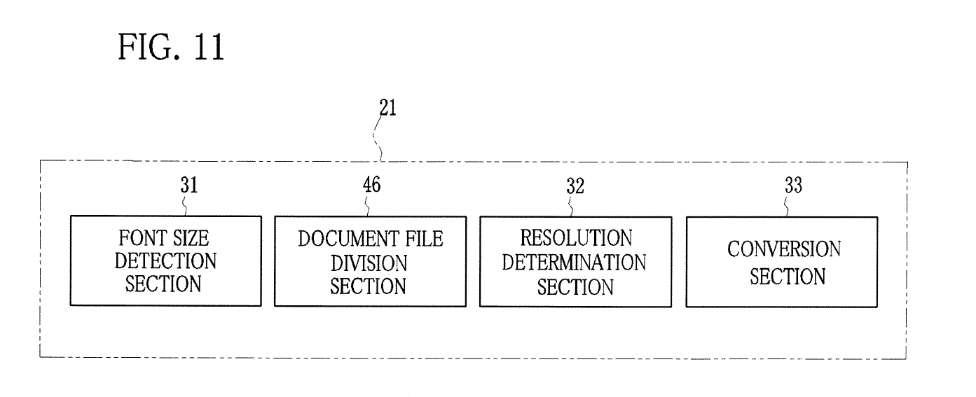

As shown in FIG. 11, the font size detection section 31, the resolution determination section 32, the conversion section 33, and a document file division section 46 are established in the CPU 21 by execution of the program. The font size detection section 31 detects the font sizes of the text data contained in the document file.

In accordance with the font sizes detected by the font size detection section 31, the document file division section 46 divides the document file loaded into the RAM 23 into the blocks each of which has the string of the letters of the same or similar font size.

The resolution determination section 32 determines the resolutions of the document images to be generated on a block-by-block basis, in accordance with the font sizes detected by the font size detection section 31.

The conversion section 33 converts the document file into the document images of individual blocks divided by the document file division section 46, at the resolutions determined by the resolution determination section 32.

The converted document images are written to the RAM 23, and are successively sent to the cellular phone 11 on a block-by-block basis in response to the browsing request. On the LCD 13 of the cellular phone 11, the document images are displayed for a browse.

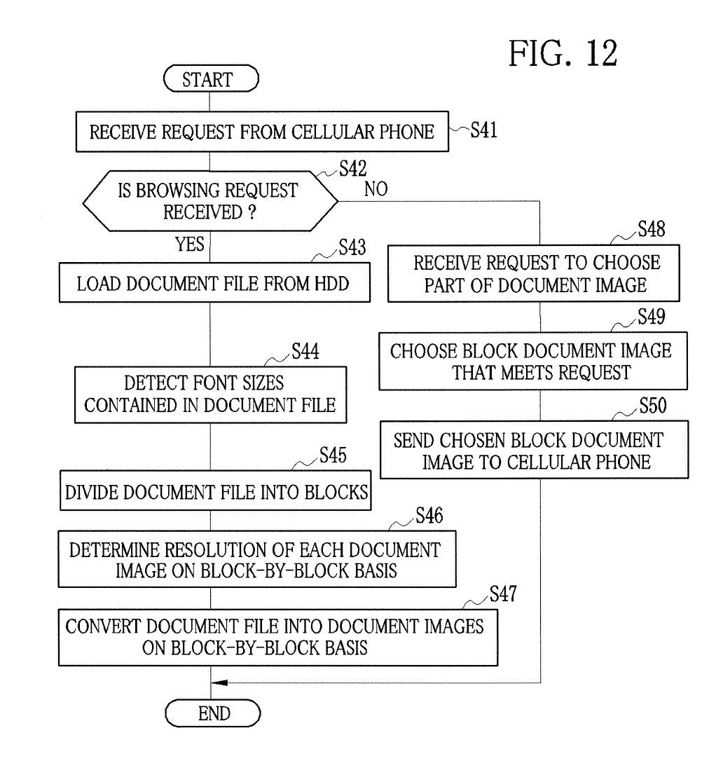

Next, the document image generation process by the document image generation server 12 of the sixth embodiment will be described with referring to FIGS. 12. S41 to S43 are the same as S31 to S33 of the fifth embodiment. When the document file is loaded into the RAM 23, the font size detection section 31 detects the font sizes contained in the document file (S44). Based on the detected font sizes, the document file division section 46 divides the document file into the blocks each of which has the string of the letters of the same or similar font size (S45). Then, the resolution determination section 32 determines the resolution of each document image to be converted from the document file on a block-by-block basis, in accordance with the font size of the letters contained in the block (S46).

Upon determination of the resolutions, the conversion section 33 converts the document file into the document images (block document images) of the individual blocks divided by the document file division section 46, at the determined resolutions (S47).

While the document image is browsed (NO in S42), if the document image generation server 12 receives a request to choose a part of the document image that is being browsed on the cellular phone 11 (S48), then the block document image containing the chosen part is chosen, or the block document image containing the highest proportion of the chosen part is chosen if the chosen part lies across the plural blocks (S49).

The chosen block document image/images is/are successively sent to the cellular phone 11 via the wireless communication section 25 and the antenna 26 (S50), and browsed on the cellular phone 11.

As described above, since the document file is divided in accordance with the font sizes and converted into the document images of the adequate resolutions, only a part of the document file has to be subjected to high-resolution processing. Therefore, the same effect as those of the above embodiments is obtained.

By combination of the fifth embodiment and the sixth embodiment, the low-resolution document images may be first generated. Then, if the zoom-in request is received while the low-resolution document image is browsed, the document file may be divided into the blocks each of which has the string of the letters of the same or similar font size, and the block document images may be generated.

### Seventh Embodiment

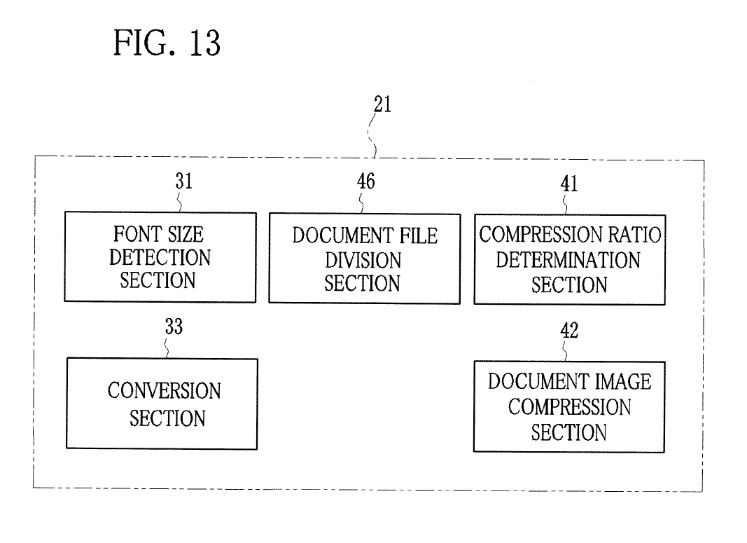

In a seventh embodiment, the document file is divided into the blocks according to the font sizes, and the compression ratio of each document image is determined on a block-by-block basis. As shown in FIG. 13, the font size detection section 31, the conversion section 33, the compression ratio determination section 41, the document image compression section 42, and the document file division section 46 are established in the CPU 21 by execution of the program. The font size detection section 31 detects the font sizes of the text data contained in the document file.

The document file division section 46, as in the case of the sixth embodiment, divides the document file loaded into the RAM 23 into the blocks each of which has the string of the letters of the same or similar font size.

The compression ratio determination section 41 determines the compression ratio (Q value) of the document image of each block divided by the document file division section 46, based on the font size of the letters contained in the block. The document image compression section 42 compresses each document image, which is converted by the conversion section 33 from the document file, at the Q value determined by the compression ratio determination section 41. The Q value is precisely applied to each block divided by the document file division section 46 in a widely known way pursuant to the JPEG.

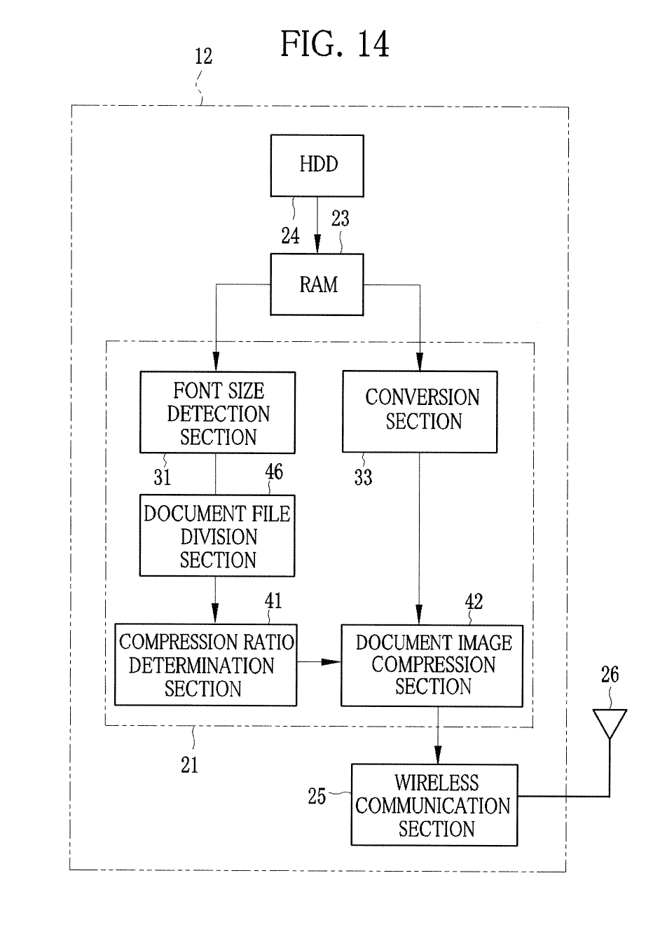

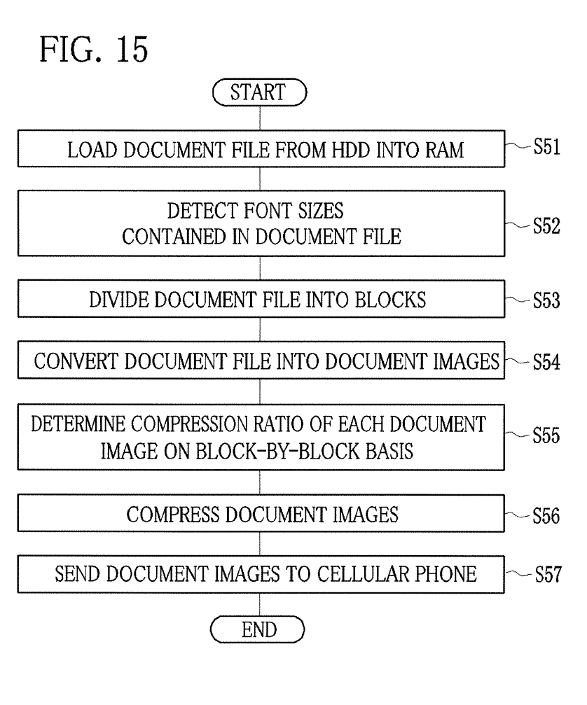

Next, the document image generation process by the document image generation server 12 of the seventh embodiment will be described with referring to FIGS. 14 and 15. S51 is the same as S21. S52 and S53 are the same as the S44 and S45 of the sixth embodiment, respectively. S54 is the same as S23. The compression ratio determination section 41 determines the compression ratio (Q value) of the document image on a block-by-block basis in accordance with the font size detected by the font size detection section 31 (S55) . S56 and S57 are the same as S25 and S26, respectively. The compressed document image is decompressed by the cellular phone 11, and is browsed on the cellular phone 11.

In the above embodiments, the document image generation program is stored in the HDD 24 of the document image generation server 12, but may be stored in an external recording medium instead. In this case, the CPU 21 generates the document images based on the image generation program loaded from the recording medium.

In the above embodiments, the document file division section may divide the document file into the predetermined units each of which has approximately the same two dimensional size, instead of into the blocks each of which has the string of the letters of the same or similar font size.

In the above embodiments, the cellular phone 11 constitutes the document browsing system. However, the document browsing system may be constituted of any communication terminal such as a notebook PC and a hand-held game machine, as long as the terminal is provided with a monitor.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. A document image generation server comprising:
a document file loading section for loading a document file containing information about one or more letters and a font size of each of the letters;
a font size detection section for detecting the font size contained in the document file;
a document file division section for dividing the document file into predetermined units having substantially a same two dimensional size or into blocks, each of the blocks having a string of the letters of substantially the same font size; and
a conversion section for converting the document file on a unit-by-unit or block-by-block basis into document images to be browsed on a terminal, a resolution of each of the document images depending on the font size contained in the unit or the block.

2. The document image generation server according to claim 1, further comprising:
an image output section for outputting the document images on a unit-by-unit or block-by-block basis in response to a request from the terminal.

3. A document image generation server comprising:
a document file loading section for loading a document file containing information about one or more letters and a font size of each of the letters;
a font size detection section for detecting the font size contained in the document file;
a document file division section for dividing the document file into predetermined units having substantially a same two dimensional size or into blocks, each of the blocks having a string of the letters of substantially the same font size;
a conversion section for converting the document file on a unit-by-unit or block-by-block basis into document images to be browsed on a terminal;
a compression ratio determination section for determining a compression ratio of each of the document images based on the font size contained in the unit or the block; and
a document image compression section for compressing each of the document images at the determined compression ratio on a unit-by-unit or block-by-block basis.

4. The document image generation server according to claim 3, further comprising:
an image output section for outputting the compressed document images in response to a request from the terminal.

5. A document image generation program for making a server execute the steps of:
loading a document file containing information about one or more letters and a font size of each of the letters;
detecting the font size contained in the document file;
dividing the document file into predetermined units having substantially a same two dimensional size or into blocks, each of the blocks having a string of the letters of substantially the same font size; and
converting the document file on a unit-by-unit or block-by-block basis into document images to be browsed on a terminal, a resolution of each of the document images depending on the font size contained in the unit or the block.

6. A document image generation program for making a server execute the steps of:
loading a document file containing information about one or more letters and a font size of each of the letters;
detecting the font size contained in the document file;
dividing the document file into predetermined units having substantially a same two dimensional size or into blocks, each of the blocks having a string of the letters of substantially the same font size;
converting the document file on a unit-by-unit or block-by-block basis into document images to be browsed on a terminal;
determining a compression ratio of each of the document images based on the font size contained in the unit or the block; and
compressing each the document images at the determined compression ratio on a unit-by-unit or block-by-block basis.

7. A document browsing system comprising:
(A) a document image generation server, including:
a document file loading section for loading a document file containing information about one or more letters and a font size of each of the letters;
a font size detection section for detecting the font size contained in the document file;
a document file division section for dividing the document file into predetermined units having substantially a same two dimensional size or into blocks, each of the blocks having a string of the letters of substantially the same font size;
a conversion section for converting the document file on a unit-by-unit or block-by-block basis into document images, a resolution of each of the document images depending on the font size contained in the unit or the block; and
an image output section for outputting the document images on a unit-by-unit or block-by-block basis; and
(B) a terminal for receiving the document images and allowing a browse of the document images.

8. The document browsing system according to claim 7, wherein the terminal is a cellular phone.

9. A document browsing system comprising:
(A) a document image generation server, including:
a document file loading section for loading a document file containing information about one or more letters and a font size of each of the letters;
a font size detection section for detecting the font size contained in the document file;
a document file division section for dividing the document file into predetermined units having substantially a same two dimensional size or into blocks, each of the blocks having a string of the letters of substantially the same font size;
a conversion section for converting the document file on a unit-by-unit or block-by-block basis into document images;
a compression ratio determination section for determining a compression ratio of each of the document images based on the font size contained in the unit or the block;
a document image compression section for compressing each of the document images at the determined compression ratio on a unit-by-unit or block-by-block basis; and
an image output section for outputting the compressed document images on a unit-by-unit or block-by-block basis; and
(B) a terminal for decompressing the document images received from the image output section and allowing a browse of the document images.

10. The document browsing system according to claim 9, wherein the terminal is a cellular phone.
